(19) United States
(12) Patent Application Publication
(10) Pub. No.: US 2023/0252203 A1
(43) Pub. Date: Aug. 10, 2023

(54) MULTIDISCIPLINARY STRUCTURAL DESIGN OPTIMIZATION METHOD FOR FUEL ASSEMBLY BASED ON CO-SIMULATION

(71) Applicant: DALIAN UNIVERSITY OF TECHNOLOGY, Dalian, Liaoning (CN)

(72) Inventors: Xueguan SONG, Dalian, Liaoning (CN); Changan ZHOU, Dalian, Liaoning (CN); Kunpeng LI, Dalian, Liaoning (CN); Xiwang HE, Dalian, Liaoning (CN); Qingye LI, Dalian, Liaoning (CN)

(21) Appl. No.: 17/780,290

(22) PCT Filed: Oct. 18, 2021
(86) PCT No.: PCT/CN2021/122533

§ 371 Date: May 26, 2022

(30) Foreign Application Priority Data
Jun. 10, 2021 (CN) 202110647968.3

(51) Int. Cl. G06F 30/20; G06F 30/17

(52) U.S. Cl. CPC G06F 30/20; G06F 30/17; G06F 2119/08

(57) ABSTRACT

A multidisciplinary structural design optimization method for a fuel assembly based on co-simulation takes the fuel assembly as a research object, and establishes a surrogate model by determining appropriate optimization design parameters with respect to the optimization requirements and low design of experiments efficiency of the fuel assembly under the working conditions of flow, solid and thermal multidisciplinary coupling. At the same time, the method combines optimization algorithms to realize the structural optimization design of a flaky fuel assembly with multiple narrow flow channels based on the characteristic of rapid optimization of ISIGHT, thereby effectively solving the problem of uneven temperature distribution of the structure. The method integrates NX, ICEM CFD, FLUENT and ABAQUS based on ISIGHT to construct a co-simulation platform, does not need to repeatedly manually set the software in multiple calculations, and can greatly save time cost while satisfying design requirements, and can shorten an optimization cycle.

### TECHNICAL FIELD

The present invention belongs to the field of design of fuel assemblies, and relates to a multidisciplinary structural design optimization method for a fuel assembly based on co-simulation, which is used for increasing the optimization efficiency of a fuel assembly structure while satisfying design requirements and is suitable for the optimization of the mechanical structures of various flaky fuel assemblies.

### BACKGROUND

The fuel assembly is a core component of a nuclear reactor, and its performance directly affects the normal operation of the nuclear reactor. However, the working environment is particularly harsh, and the safety and the reliability of the fuel assembly are seriously affected under working conditions of scouring by high temperature, high pressure and high velocity coolants for a long time. Therefore, under the condition that flow characteristics, solid characteristics and thermal characteristics have important influences on the operation performance of the fuel assembly, it is of great significance to develop a novel optimization method for structural design under multidisciplinary coupling condition for ensuring the normal operation of the fuel assembly and increasing the service life.

The patent for invention CN201910166484.X proposes an optimization method and device for a positioning lattice of a fuel assembly, but the optimization process fails to consider the operation state of the multidisciplinary coupling effect of the fuel assembly, and the optimization method is not thoroughly compared and verified.

The traditional optimization method is generally completed by design of experiments. Although the method can increase the optimization efficiency to a certain extent, the selection of design variables is discrete and an optimal solution cannot be found accurately. On the basis of design of experiments, the present invention adopts a surrogate model technology, which can better solve the defects brought by the traditional optimization method and find the optimal solution more accurately. Moreover, an optimization method based on ISIGHT co-simulation can greatly reduce the disadvantage of high time cost caused by continuous manual adjustment and updating of a geometric model and manual setting of numerical simulation calculation parameters, and can greatly shorten an optimization cycle.

The fuel assembly is cooled and dissipated in a way of fast flow of a cooling medium. The heat power distribution of a fuel assembly core of the fuel assembly is not uniform, and the width of each flow channel has a very important influence on the heat dissipation of the fuel assembly core. Therefore, the present invention selects the width of each fluid channel as a design parameter, and integrates NX, ICEM CFD, FLUENT and ABAQUS into optimization software ISIGHT to realize a joint simulation platform for structural optimization of the fuel assembly.Based on design of experiments, optimization design is conducted on the fuel assembly by constructing a surrogate model, so as to obtain an optimal flow channel size.

### SUMMARY

The technical problems to be solved by the present invention are: to overcome the defect that the traditional optimization method cannot accurately find an optimal solution, and simultaneously to overcome the problems of high time cost and low optimization efficiency caused by continuously manually adjusting geometric models and setting numerical simulation calculation parameters, to propose a multidisciplinary structural design optimization method for a fuel assembly based on co-simulation, which is used to improve the optimization efficiency of structural design of the fuel assembly under complex working conditions of flow, solid and thermal multidisciplinary coupling, and is suitable for optimization of mechanical structures of various flaky fuel assemblies.

To solve the above problems, the present invention adopts the following technical solution:

A multidisciplinary structural design optimization method for a fuel assembly based on co-simulation is proposed. The method takes the fuel assembly as a research object, and establishes a surrogate model through Kriging by determining appropriate optimization design parameters with respect to the optimization requirements and low design of experiments (DOE) efficiency of the fuel assemblyunder the working conditions of flow, solid and thermal multidisciplinary coupling. At the same time, the present invention combinesan adaptive simulated annealing algorithm (ASA), a multi island genetic algorithm (MIGA), a Hooke-Jeeves direct search algorithm (Hooke-Jeeves), a continuous quadratic programming algorithm (NLPQLP), a generalized reduction gradient algorithm (LSGRG) and other optimization algorithms torealize the structural optimization design of the flaky fuel assembly with multiple narrow flow channels based on the characteristic of rapid optimization of ISIGHT, thereby effectively solving the problem of uneven temperature distribution of the structure.

The multidisciplinary structural design optimization method for the fuel assembly comprises the following steps:

first step:integrating NX, ICEM CFD, FLUENT and ABAQUS based on ISIGHT software to build a fuel assembly co-simulation platform which comprises a geometric model update module, a mesh update module, a flow and heat transfer calculation module, a solid mechanics calculation module and a dataprocessing moduleas follows:
1.1) establishinga geometric model of the fuel assembly in NX, which comprises 8 flow channels, 7 fuel assembly cores, 7 aluminum claddings and 1 dentate plate; parameterizing the sizes of8 flow channel widths of the fuel assembly, exporting an NX expression file in .EXP format, recording an NX operation record file in .VB format, and outputtinga geometric model file in .STP format;
1.2) establishing a batch file which uses NX to execute the geometric model update module; importing the batch file into an ISIGHT general component SIMCODE;writing the flow channel width parameters, obtained in step 1.1), in the NX expression file in .EXP format into ISIGHT to serve as design parameters; driving NX to update the geometric model; and outputting the updated general geometric model file in .STP format to realize integration between two pieces of software of ISIGHT and NX;
1.3) savingan ICEM CFD meshing process as a macro file in .RPL format;
1.4) establishing a batch file which uses ICEM CFD to execute the mesh update module; importing the batch file into the ISIGHT general component SIMCODE; readinga general 3D geometric model file in .STP format; driving ICEM CFD to update the mesh; and outputtingthe updated mesh file in .MSH format to realize integration between two pieces of software of ISIGHT and ICEM CFD;
1.5) savingan FLUENT flow and heat transfer calculation process as a macro file in .JOU format;
1.6) establishing a batch file which uses FLUENT to execute aflow and heat transfer numerical calculation module; importing the batch file into ISIGHT general component SIMCODE; readingamesh file in .MSH format and a UDF file in C format driving FLUENT for flow and heat transfer numerical calculation; and saving the data after the calculation into a text file in .VRP format to realize integration between two pieces of software of ISIGHT and FLUENT, wherein 4 .VRP text files are comprised;a firsttext file stores the comprehensive indexesRᵢ (i = 1, 2,..., 8) of each flow channel, a second text file stores the highest node temperature
$${T}_{i}^{α} \left(i = 1 , 2 , … , 7\right)$$
of each fuel assembly core, a third text file stores the highest node temperature
$${T}_{i}^{β} \left(i = 1 , 2 , … , 7\right)$$
of each aluminum cladding, and the fourth text file stores the maximum hydrostatic static pressurePᵢ (i = 1, 2,..., 8) of each channel wall surface;
1.7) integratinga CALCULATOR component based on the ISIGHT software; establishing a data processing module;usingmax, stdDev sum functions in the component to process the data
$${R}_{i} , {T}_{i}^{α} , {T}_{i}^{β} \text{and} {P}_{i}$$
extracted in step 1.6; and calculating the following data:
the highest node temperature
$${T}_{m a x}^{f u e l} , {T}_{m a x}^{f u e l} = max \left({T}_{1}^{α} , {T}_{2}^{α} , … , {T}_{7}^{α}\right)$$
of the fuel assembly core;
maximum node temperature standard deviation
$${T}_{S D}^{f u e l} , {T}_{S D}^{f u e l} = \text{stdDev} \left({T}_{1}^{α} , {T}_{2}^{α} , … , {T}_{7}^{α}\right)$$
of the fuel assembly core;
highest node temperature
$${T}_{m a x}^{a l} , {T}_{m a x}^{a l} = max \left({T}_{1}^{β} , {T}_{2}^{β} , … , {T}_{7}^{β}\right)$$
of all aluminum claddings;
maximum hydrostatic static pressure Pₘₐₓ,Pₘₐₓ = max (P₁,P₂,...,P₈) of each channel wall surface;
average value Rₐᵥ,Rₐᵥ=(sum(R₁,R₂, ...,R₈))/8 of the comprehensive index of each flow channel;
1.8) saving the ABAQUS solid mechanics calculation process as a macro file in .PY format;
1.9) establishing a batch file whichuses ABAQUS to execute the solid mechanics calculation module; importing the batch file into the ISIGHT general component SIMCODE;writing the maximum hydrostatic static pressurePₘₐₓ on the wall surfaces of all the flow channels and the maximum node temperature
$${T}_{m a x}^{a l}$$
of all the aluminum claddings, calculated by the CALCULATOR component, into ISIGHT to serve as intermediate variables and transmit to ABAQUS; reading the 3D geometric model file in .STP format; driving ABAQUS to perform solid mechanics calculation; saving the data after the calculation into a text file in.TXT format to realize integration between two pieces of software of ISIGHT and ABAQUS, wherein the text file in.TXT formatstores maximum Mises equivalent stress
$${S}_{i}^{α} \left(i = 1 , 2 , … , 8\right)$$
of each fuel assembly core, the maximum Mises equivalent stress S_{θ} of the dentate plate, and the maximum Mises equivalent stress
$${S}_{i}^{β} \left(i = 1 , 2 , … , 7\right)$$
of each aluminum cladding;
1.10) integrating the CALCULATOR component based on the ISIGHT software; establishing a data processing module; usinga max function in the component to process the data
$${S}_{i}^{α} , {S}_{θ} \text{and} {S}_{i}^{β}$$
extracted in step 1.9; and calculating the following data:
the overall maximum Mises stress
$${S}_{m a x ,} {S}_{m a x} = max \left({S}_{1}^{α} , … , {S}_{7}^{α} , {S}_{1}^{β} , … , {S}_{7}^{β} , {S}_{θ}\right)$$
of the fuel assembly.

Second step: determining the design parameters, optimization objectives and constraint conditions of the optimization model, and selectingan appropriate experimental design method, surrogate model and optimization algorithm as follows:
2.1) the design parameters are selected as the widthsLᵢ(i = 1, 2,..., 8) of the flow channels because the heating power distribution of the fuel assembly core of the fuel assembly is not uniform, and the width of each flow channel has a very important influence on the heat dissipation of the fuel assembly core, which needs to determine the most effective flow channel width for heat dissipation of the fuel assembly;
2.2) as mentioned above, the heating power distribution of the fuel assembly core is not uniform;this non-uniformity leads to non-uniformity of temperature distribution of the fuel assembly core;if the temperature gradient between the fuel assembly cores is too large, the overall service life of the fuel assembly is greatly reduced; the standard deviation is usually used to describe the non-uniformity of the data distribution; and thus, the selection of the optimization objectives is described by a function as: min
$${T}_{S D}^{f u e l} \left({L}_{1} , {L}_{2} , ⋯ , {L}_{8}\right)$$
where
$${T}_{S D}^{f u e l}$$
is the highest node temperature standard deviation of each fuel assembly core;

$${T}_{S D}^{f u e l} = \sqrt{\frac{{\sum }_{i = 1}^{7} {\left({T}_{i}^{α} - \overline{T}\right)}^{2}}{7}} ; {T}_{i}^{α}$$
is the highest node temperature of the ith fuel assembly core; T̅̅ is the average value of the highest node temperature of each fuel assembly core;
$$\overline{T} = \frac{{\sum }_{i = 7}^{7} {T}_{i}^{α}}{7} ;$$
L₁,L₂, ...,L₈ are the widths of the flow channels;
2.3) in addition to the important influence ofnon-uniform temperature distribution of the fuel assembly core on the service life of the fuel assembly, the average value Rₐᵥ of the comprehensive indicators of each flow channel, the overall maximum Mises stress Sₘₐₓ of the fuel assembly, and the highest node temperature
$${T}_{m a x}^{f u e l}$$
of all the fuel assembly cores also have a certain influence on the service life; it is expected that Rₐᵥ is as large as possible, Sₘₐₓ is as small as possible, and
$${T}_{m a x}^{f u e l}$$
is as small as possible, but the influences of the above three indicators are small relative to
$${T}_{S D}^{f u e l} ; {R}_{a v} , {S}_{m a x} \text{and} {T}_{m a x}^{f u e l}$$
can be set as constraint conditions. In addition, limited by the space conditions for the placement of the fuel assembly, the width of each flow channel should also serve as a constraint.

The constraint conditions are described as:

$$\begin{matrix}- {R}_{a v} ⩽ - {R}_{0} \\ {T}_{m a x F u e l M A X}^{f u e l} ⩽ {T}_{0} \\ {S}_{m a x} ⩽ {S}_{0} \\ 2 ⩽ {L}_{1} , {L}_{2} … , {L}_{8} ⩽ 3\end{matrix}$$

where

$${T}_{m a x}^{f u e l}$$

is the highest node temperature of all the fuel assembly cores; Sₘₐₓ is the maximum Mises equivalent stress under the flow-thermal-mechanical coupling action of the fuel assembly; R₀ is the minimum allowable value of the average comprehensive index of each flow channel; T₀ is the maximum allowable temperature of the fuel assembly; S₀ is the maximum allowable stress of the fuel assembly;

$${R}_{a v} = \frac{{\sum }_{i = 1}^{8} {R}_{i}}{8}$$

represents the average value of the comprehensive index of each flow channel;

$${R}_{i} = \frac{N {u}_{i} / N {u}_{0}}{{f}_{i} / {f}_{0}}$$

represents the comprehensive index of the ith flow channel; Nuᵢ is the Nusselt number of the ith flow channel; Nu₀ is the Nusselt number of a reference flow channel; fᵢ represents a Darcy friction coefficient of the ith flow channel; f₀ represents the Darcy friction coefficient of the reference flow channel;

$${f}_{i} = \frac{2 Δ {p}_{i} {D}_{i}}{{ρ}_{i} {U}_{i}^{2} L} ;$$

Δpᵢ is the outlet-inlet pressure drop (Pa) of the ith flow channel; Dᵢ is the hydraulic diameter (m) of the ith flow channel; ρᵢ is the average density (kg/m³) of a coolant in the ith flow channel;Uᵢ is the inlet velocity (m/s) of the ith flow channel; and L is the length of each flow channel;
2.4) the experimental design method is selected from a“Latin hypercube” experimental design method which can ensure the full coverage of a selection range of each design variable (L₁,L₂,...,L₈).The purpose of the design of experiments is to select different design parameter combinations
$$\left({L}_{1}^{j} , {L}_{2}^{j} , … , {L}_{8}^{j}\right) ,$$
and calculate the equivalent values of
$${R}_{a v}^{j} , {S}_{m a x}^{j} , {T}^{j} {}_{m a x}^{f u e l} \text{and} {T}^{j} {}_{S D}^{f u e l}$$
under each group of design parameter combinations.Each group of design parameter combinations and the calculated equivalent values of
$${R}_{a v}^{j} , {S}_{m a x}^{j} , {T}^{j} {}_{m a x}^{f u e l} \text{and} {T}^{j} {}_{S D}^{f u e l}$$
belong to one sample.The sample size is selected as 80, i.e., j =1, 2, ..., 80 .The design parameter combination
$$\left({L}_{1}^{j} , {L}_{2}^{j} , … , {L}_{8}^{j}\right) ,$$
selected by the design of experiments is discrete data, and the design of experiments determines that different samples are the key prerequisites to ensure that the surrogate model is established accurately;
2.5) the surrogate model is established based on the above samples after 80 groups of samples are selected using the “Latin hypercube” experimental design method; the purpose of the surrogate modelis to make the discrete design variables “continuous” so as to use the optimization algorithm to predict an optimal solution. The surrogate model selects a Kriging surrogate model; the Kriging surrogate model has a good approximation effect when designing parameters within 10; and the accuracy of the surrogate model is verified by R².
$${R}^{2} = \frac{S S R}{S S T}$$
where
$$S S R = \sum {}_{i = 1}^{k} {\left({\hat{y}}_{i} - \overline{y}\right)}^{2}$$
represents the regression sum of squares;
$$S S T = \sum {}_{i = 1}^{k} {\left({\hat{y}}_{i} - \overline{y}\right)}^{2}$$
represents the total sum of squares; y̅ is the average value of the responses; ŷᵢ is a predicted value on a design point; yᵢ is a true value of the responses; and k is the number of sample points;
2.6) the optimization algorithm is a calculation method for predicting an optimal value after establishing the Kriging surrogate model;the optimization algorithm selects a “multi island genetic algorithm (MIGA)”; and the MIGA is a global optimization algorithm, which can effectively preventan optimization result from falling into a local optimal solution.The optimal solution is a group of predicted design parameter values
$${{L}^{′}}_{1} , {{L}^{′}}_{2} , … , {{L}^{′}}_{8}$$
obtained by using the “MIGA” ;corresponding
$${{R}^{′}}_{a v} , {{S}^{′}}_{m a x} , {T}^{′} {\text{}}_{m a x}^{f u e l} \text{and} {T}^{′} {\text{}}_{S D}^{f u e l}$$
the design parameters
$${{L}^{′}}_{1} , {{L}^{′}}_{2} , … , {{L}^{′}}_{8}$$
are also predicted values;
$$2 ⩽ {{L}^{′}}_{1} , {{L}^{′}}_{2} , … , {{L}^{′}}_{8} ⩽ 3 ; \text{and} {{L}^{′}}_{1} , {{L}^{′}}_{2} , … , {{L}^{′}}_{8}$$
areany real numbers in a range [2,3], and may not necessarily belong to the combination
$${L}_{1}^{j} , {L}_{2}^{j} , … , {L}_{8}^{j}$$
selected by the design of experiments;
Third step: after the first and second steps are all ready, operating the fuel assembly co-simulation platform to carry out the relevant optimization operation; comparing the corresponding predicted
$$\text{value} {{T}^{′}}_{S D}^{f u e l} \text{of} {{L}^{′}}_{1} , {{L}^{′}}_{2} , … , {{L}^{′}}_{8}$$
obtained by the optimization algorithm with a corresponding actual
$$\text{value} {T}_{S D}^{\text{χ} f u e l} \text{of} {{L}^{′}}_{1} , {{L}^{′}}_{2} , … , {{L}^{′}}_{8}$$
obtained through numerical calculation; and analyzing the performance of the optimized fuel assembly, specifically as follows:
3.1) obtaining a group of predicted optimal design parameters
$${{L}^{′}}_{1} , {{L}^{′}}_{2} , … , {{L}^{′}}_{8}$$
after optimization with “MIGA”;under this group of design parameters, the corresponding
$${{R}^{′}}_{a v} , {{S}^{′}}_{m a x} \text{and} {{T}^{′}}_{m a x}^{f u e l}$$
satisfying
$$- {{R}^{′}}_{a v} \leq {R}_{0} , {{S}^{′}}_{m a x} \leq {S}_{0} \text{and} {{T}^{′}}_{m a x}^{f u e l} \leq {T}_{0} ; {{T}^{′}}_{S D}^{f u e l}$$
is a minimum value in the surrogate model.
3.2) As described in step 1.1), the width of each flow channel has been parameterized, so the width of each flow channel is set as
$${{L}^{′}}_{1} , {{L}^{′}}_{2} , … , {{L}^{′}}_{8} ;$$
and the geometric model update module, the mesh update module, the flow and heat transfer calculation module, the solid mechanics calculation module and the data processing module are executed in sequence to obtain the real calculation data
$${R}_{a v}^{\text{χ}} , {S}_{m a x}^{\text{χ}} , {T}_{m a x}^{\text{χ} f u e l} \text{and} {T}_{S D}^{\text{χ} f u e l}$$
when the design parameters are
$${{L}^{′}}_{1} , {{L}^{′}}_{2} , … , {{L}^{′}}_{8} ;$$
3.3) judging whether data
$${R}_{a v}^{\text{χ}} , {S}_{m a x}^{\text{χ}} \text{and} {T}_{m a x}^{\text{χ} f u e l}$$
satisfy
$$- {R}_{a v}^{\text{χ}} \leq - 1.1 {R}_{0} , {S}_{m a x}^{\text{χ}} \leq 1.1 {S}_{0}$$
$$\text{and} {T}_{m a x}^{\text{χ} f u e l} \leq 1.1 {T}_{0} ,$$
and calculating an error σ,
$$σ = \frac{\left|{{T}^{′}}_{S D}^{f u e l} - {T}_{S D}^{\text{χ} f u e l}\right|}{\left|{{T}^{′}}_{S D}^{f u e l}\right|}$$
between
$${{T}^{′}}_{S D}^{f u e l} \text{and}$$
3.4) if the error described in step 3.3) is less than 10%,
$${R}_{a v}^{\text{χ}} , {S}_{m a x}^{\text{χ}} \text{and} {T}_{m a x}^{\text{χ} f u e l}$$
satisfy the requirementsand the design parameters
$${{L}^{′}}_{1} , {{L}^{′}}_{2} , … , {{L}^{′}}_{8}$$
obtained after optimization are considered to be acceptable;if the error described in step 3.2) is greater than 10%, or any value of
$${R}_{a v}^{\text{χ}} , {S}_{m a x}^{\text{χ}} \text{and}$$
$${T}_{m a x}^{\text{χ} f u e l}$$
does not satisfy the requirements, the design parameters
$${{L}^{′}}_{1} , {{L}^{′}}_{2} , … , {{L}^{′}}_{8}$$
obtained after optimization are considered to be unacceptable, and the optimization process needs to be corrected;
3.5) the optimization process is modified by adding design samples of experiments, that is, adding samples based on the previous 80 groups of samples, reconstructing the surrogate model, reusing the optimization algorithm for optimization, and re-comparing the predicted value of the algorithm with the actual calculated value until the standards in steps 3.2) and 3.3) are satisfied.

Compared with the prior art, the present invention at least has the following beneficial effects:

The present invention adopts the design method of the fuel assembly optimization method based on ISIGHT co-simulation, and fully utilizes the advantages of NX, ICME CFD, FLUENT and ABAQUS in respective fields. In optimization solution, compared with manual adjustment and update of the geometric model and setting of numerical simulation calculation parameters, the present invention can greatly reduce the time cost; and the method ofsurrogate model optimization can also improve the accuracy and reliability of the optimization design.

In the present invention, after the surrogate model is established, the R² errors of

$${T}_{S D}^{f u e l} ,$$

$${R}_{a v} , {T}_{m a x}^{f u e l} \text{and} {S}_{m a x}$$

obtained by error analysis are 0.99806, 0.99725, 0.91674 and 0.98714, respectively, indicating that the fitting degree is very good, and the surrogate model can be used to replace a real model for optimization.

The present invention adopts the multiisland genetic algorithm (Multi-Island GA) as the optimization algorithm, and verifies the predicted results

$${{R}^{′}}_{a v} , {{S}^{′}}_{m a x} , {{T}^{′}}_{m a x}^{f u e l} \text{and} {{T}^{′}}_{S D}^{f u e l}$$

of each optimization algorithm and the actual calculated results

$${R}_{a v}^{\text{χ}} , {S}_{m a x}^{\text{χ}} , {T}_{m a x}^{\text{χ} f u e l} \text{and} {T}_{S D}^{\text{χ} f u e l} ,$$

which can effectively prevent the predicted value obtained by the optimization algorithm from falling into the problems of the local optimal solution and unreliable optimization results.

The present invention performs digital calculation and verification through the design method of the fuel assembly optimization method based on ISIGHT co-simulation, which can provide a corresponding theoretical basis for the experiments, reduce the excessive experimental cost caused by blind experiments, and improve the overall performance of the flaky fuel assembly.

### DESCRIPTION OF DRAWINGS

FIG. 1(a) is a schematic diagram of a three-dimensional model of a fuel assembly in the present invention;

FIG. 1(b) is a sectional view of a fuel assembly;

FIG. 2 is a flow chart of a method of the present invention.

FIG. 3 is a construction diagram of an ISIGHT co-simulation optimization platform and

FIG. 4 is a Multi-Island GA optimization process diagram of the present invention.

In the drawings: 1 fluid domain; 2 fuel assembly core; 3 dentate plate; 4 aluminum cladding.

### DETAILED DESCRIPTION

The present invention will be further described below in combination with the drawings and specific embodiments. Apparently, the described embodiments are part of the embodiments of the present invention, not all of the embodiments.The present invention should not be limited to the embodiments, and other multidisciplinary coupling optimization designs realized by the method are all within the protection scope of the present invention.

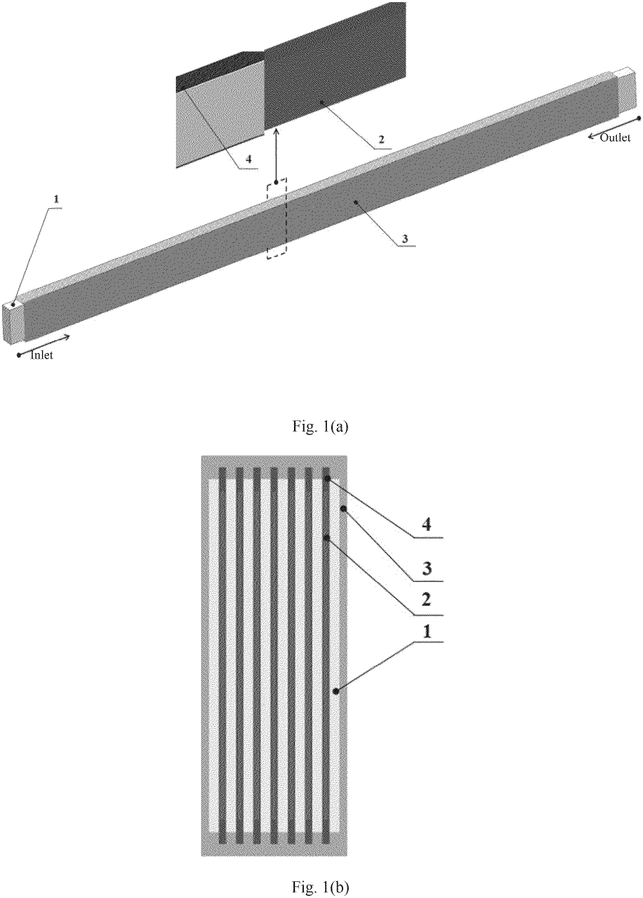

FIG. 1 is a schematic diagram of a three-dimensional model of a fuel assembly of the present invention, including a fluid domain 1, a fuel assembly core 2, a dentate plate 3 and an aluminum cladding 4.The fuel assembly core is arranged in the core of the aluminum cladding; the aluminum cladding is fixed by adentate plate clamping groove; and a fluid medium in the fluid domain flows rapidly from flow channels between the aluminum claddings to achieve the effects of cooling.

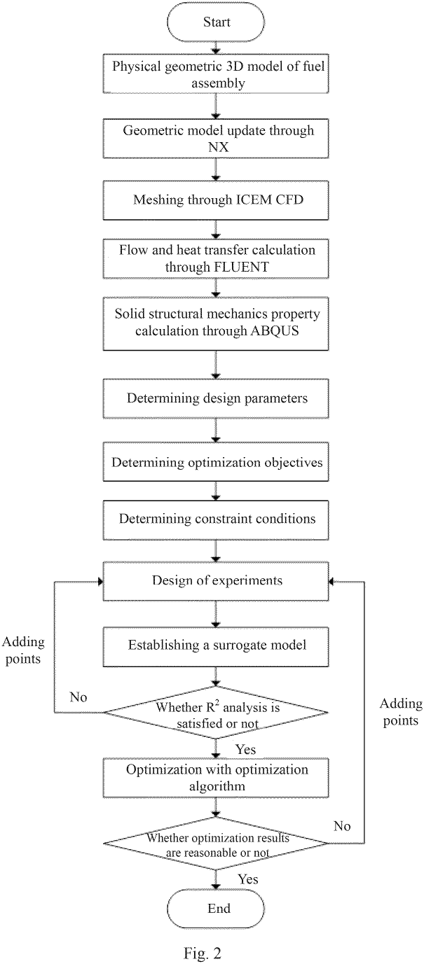

FIG. 2 is a flow chart of a structural optimization design method of a fuel assembly based on ISIGHT co-simulation. According to the actual situation of the optimization design of the fuel assembly, NX, ICEM CFD, FLUENT and ABAQUS are integrated through ISIGHT to construct a co-simulation platform.NX can parameterize the size and characteristics of the fuel assembly through parametric modeling, and output a general 3D geometric model file in .STP format. ICME CFD can mesh the 3D geometric model, and output a mesh file in .MSH format. FLUENT can perform mesh assembly on the .MSHmesh file, perform numerical simulation calculation on the flow and heat dissipation of the cooling medium, and output the hydrostatic static pressure, temperature and other data after the calculation into a .VRP file for ABAQUS for data input. ABAQUS can perform numerical simulation calculation on solid parts such as a fuel assembly dentate plate, aluminum claddings and fuel assembly cores based on the hydrostatic static pressure, temperature and other data outputted by FLUENT, and can output the maximum Mises stress of the solid parts into a .TXT file.After the co-simulation platform is built, design parameters, optimization objectives, and constraint conditions are determined, and then sample points are selected through Design of Experiments (DOE).Asurrogate model is established based onDOE, and the accuracy of the surrogate model is verified by R². If the accuracy meets the requirements, the optimization algorithm is used for optimization prediction. If the accuracy does not meet the requirements, new sample points need to be determined, and the surrogate model is reconstructed until the test by R² is qualified.After the optimization of the optimization algorithm is completed, it is necessary to judge whether the predicted optimization results and the actual calculated results meet the relevant requirements. If the requirements are met, it indicates that the optimization results are desirable. If the requirements are not met, new sample points need to be determined, and the surrogate model is reconstructed until the predicted optimization results and the actual calculated results meet the relevant requirements on the basis that the test by R² is qualified.

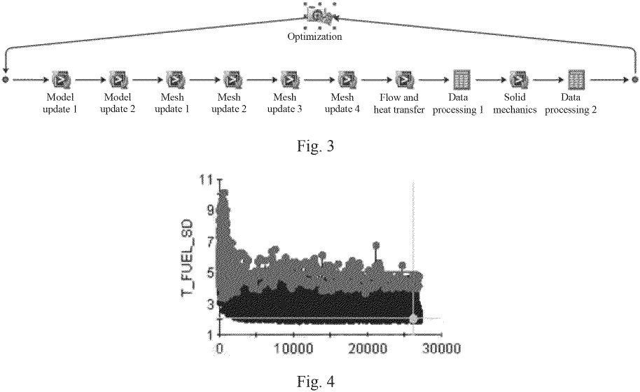

FIG. 3 is a construction diagram of an optimization platform of the structural design optimization method of the fuel assembly based on ISIGHT co-simulation, including 8 SIMCODE components, i.e., model update 1, model update 2, mesh update 1, mesh update 2, mesh update 3, mesh update 4, flow and heat transfer and solid mechanics, as well as two calculator components, i.e., data processing 1 and data processing 2.The SIMCODE components are used to drive NX for geometric model update, drive ICEM CFD for meshing, drive FLUENT for flow and heat transfer numerical calculation, and drive ABAQUS for solid mechanics simulation calculation respectively; data processing 1 and data processing 2 are respectively used to process the data outputted by FLUENT and ABAQUS; and Optimization is used to establish thesurrogate model and perform optimization through the optimization algorithm.

FIG. 4 shows the optimization process of the Multi-IslandGA as the optimization algorithm. This algorithm is a global optimization algorithm, and the optimization process is iterated for 27,000 times.

Table 1 is a data mapping relationship diagram of the present invention, which specifically shows the relationships between L₁,L₂,...,L₈ and

$$\begin{matrix}{L}_{1}^{i} , {L}_{2}^{i} , … , {L}_{8}^{i} , & {{L}^{′}}_{1} , {{L}^{′}}_{2} , … , {{L}^{′}}_{8} , & {R}_{a v}^{i} , & {S}_{m a x}^{i} ,\end{matrix}$$

$${\text{T}}^{\text{j}} {}_{\text{max}}^{\text{fuel}} {\text{, T}}^{\text{j}} {}_{\text{SD}}^{\text{fuel}} {\text{, R}}_{\text{av}}^{\text{′}} \text{,} {\text{S}}_{\text{max}}^{\text{′}} {\text{, T′}}_{\text{max}}^{f u e l} \text{,} {\text{T′}}_{\text{SD}}^{f u e l} , {R}_{a v}^{x} , {S}_{max}^{x} , {\text{T}}^{\text{x}} {}_{\text{max}}^{f u e l} , {\text{T}}^{\text{x}} {}_{\text{SD}}^{f u e l} .$$

TABLE 1

Data mapping relationship diagram of the present invention
${L}_{1} , {L}_{2} , … , {L}_{8} , \left\{\begin{matrix}{L}_{1}^{1} , {L}_{2}^{1} , … , {L}_{8}^{1} , \to {R}_{a v}^{1} , {S}_{m a x}^{1} , {T}_{m a x}^{1 f u e l} , {T}_{S D}^{1 f u e l} \\ {L}_{1}^{2} , {L}_{2}^{2} , … , {L}_{8}^{2} , \to {R}_{a v}^{2} , {S}_{m a x}^{2} , {T}_{m a x}^{2 f u e l} , {T}_{S D}^{2 f u e l} \\ ⋮ \\ {L}_{1}^{80} , {L}_{2}^{80} , … , {L}_{8}^{80} , \to {R}_{a v}^{80} , {S}_{m a x}^{80} , {T}_{m a x}^{80 f u e l} , {T}_{S D}^{80 f u e l} \\ {{L}^{′}}_{1} , {{L}^{′}}_{2} , … , {{L}^{′}}_{8} \left\{\begin{matrix}\to {{R}^{′}}_{a v} , {{S}^{′}}_{m a x} , {{T}^{′}}_{m a x}^{f u e l} , \left(\left(\text{Algorithm predicted value}\right)\right) \\ \to {R}_{a v}^{\text{χ}} , {S}_{m a x}^{\text{χ}} , {T}_{m a x}^{\text{χ} f u e l} , \left(\text{Algorithm predicted value}\right)\end{matrix}\right)\end{matrix}\right)$

Table 2 shows the corresponding purposes of each format file, including different types such as 3D geometry files, mesh files, batch files, macro files and data files.

TABLE 2

File formats and purposes

| | |
|---|---|
| File formats | Purposes |
| .PRT | NXdefault geometric model file. |
| .EXP | NX8.5expression file, which records all parametric information of the part model. |
| .VB | NX8.5operation record file, which records reading expressions, updates model sizes, saves and outputs .STP general format and related information. |
| .STP | Stp203part format, which belongs to the general geometric model file format and is used to transfer model information for convenience of reading by the software. |
| .BAT | batch file, which is used for starting various applications. |
| .RPL | ICEM CFD operation record file, which records the meshing operation process. |
| .MSH | ICEM CFDmesh file, which respectively records the mesh information for FLUENT. |
| .JOU | FLUENToperation record file, which records Fluent related operation processes. |
| .C | UDF file of FLUENT, which records custom functions in Fluent. |
| .VRP | Text file, which records data such as pressure, temperature and variance read from FLUENT. |
| .PY | ABAQUSoperation record file, which records ABAQUSrelated operation processes. |
| .TXT | Text file, which records data such as stress read from ABAQUS. |
| .ZMF | ISIGHT project files. |

Table 3 shows the comparison of the data results before and after optimization, from which the improvement of each index can be obtained.

TABLE 3

| | Rₐᵥ | Sₘₐₓ | ${T}_{max}^{f u e l}$ | ${T}_{S D}^{f u e l}$ |
|---|---|---|---|---|
| Before optimization | 0.333491 | 160.0513 | 262.6568 | 4.7108 |
| After optimization | 0.330024 | 158.0250 | 258.5701 | 1.7229 |
| Improvement | -1.04% | 1.27% | 1.56% | 63.43% |

By referring to FIG. 1 to FIG. 4, a multidisciplinary structural design optimization method for a fuel assembly based on co-simulation comprises the following steps:

first step: integrating NX, ICEM CFD, FLUENT and ABAQUS based on ISIGHT software to build a fuel assembly co-simulation platform which comprises a geometric model update module, a mesh update module, a flow and heat transfer calculation module, a solid mechanics calculation module and a data processing module as follows:
1.1) establishing a geometric model of the fuel assembly in NX, which comprises 8 flow channels, 7 fuel assembly cores, 7 aluminum claddings and 1 dentate plate; parameterizing the sizes of 8 flow channel widths of the fuel assembly, exporting an NX expression file in .EXP format, recording an NX operation record file in .VB format, and outputting a geometric model file in .STP format;
1.2) establishing a batch file which uses NX to execute the geometric model update module; importing the batch file into an ISIGHT general component SIMCODE; writing the flow channel width parameters, obtained in step 1.1), in the NX expression file in .EXP format into ISIGHT to serve as design parameters; driving NX to update the geometric model; and outputting the updated general geometric model file in .STP format to realize integration between two pieces of software of ISIGHT and NX;
1.3) saving an ICEM CFD meshing process as a macro file in .RPL format;
1.4) establishing a batch file which uses ICEM CFD to execute the mesh update module; importing the batch file into the ISIGHT general component SIMCODE; reading a general 3D geometric model file in .STP format; driving ICEM CFD to update the mesh; and outputting the updated mesh file in .MSH format to realize integration between two pieces of software of ISIGHT and ICEM CFD;
1.5) saving an FLUENT flow and heat transfer calculation process as a macro file in .JOU format;
1.6) establishing a batch file which uses FLUENT to execute a flow and heat transfer numerical calculation module; importing the batch file into ISIGHT general component SIMCODE; reading a mesh file in .MSH format and a UDF file in .C format; driving FLUENT for flow and heat transfer numerical calculation; and saving the data after the calculation into a text file in .VRP format to realize integration between two pieces of software of ISIGHT and FLUENT, wherein 4 .VRP text files are comprised; a first text file stores the comprehensive indexes Rᵢ (i = 1, 2, ..., 8) of each flow channel, a second text file stores the highest node temperature
$${T}_{i}^{α}$$
(i = 1, 2, ...,7) of each fuel assembly core, a third text file stores the highest node temperature
$${T}_{i}^{β} \left(i = 1 , 2 , … , 7\right)$$
of each aluminum cladding, and the fourth text file stores the maximum hydrostatic static pressure Pᵢ(i = 1, 2,..., 8) of each channel wall surface;
1.7) integrating a CALCULATOR component based on the ISIGHT software; establishing a data processing module; using max, stdDev, sum functions in the component to process the data Rᵢ
$${T}_{i}^{α} , {T}_{i}^{β}$$
and Pᵢ extracted in step 1.6; and calculating the following data:
the highest node temperature
$${T}_{m a x}^{f u e l} , {T}_{m a x}^{f u e l} = m a x \left({T}_{1}^{α} , {T}_{2}^{α} , … , {T}_{7}^{α}\right)$$
of the fuel assembly core; maximum node temperature standard deviation
$${T}_{S D}^{f u e l} , {T}_{S D}^{f u e l} = \text{stdDev} \left({T}_{1}^{α} , {T}_{2}^{α} , … , {T}_{7}^{α}\right)$$
of the fuel assembly core;
highest node temperature
$${T}_{m a x}^{a l} , {T}_{m a x}^{a l} = m a x \left({T}_{1}^{β} , {T}_{2}^{β} , … , {T}_{7}^{β}\right)$$
of all aluminum claddings;
maximum hydrostatic static pressure Pₘₐₓ,Pₘₐₓ = max (P₁,P₂,...,P₈) of each channel wall surface;
average value Rₐᵥ,Rₐᵥ=(sum(R₁,R₂,...,R₈))/8 of the comprehensive index of each flow channel;
1.8) saving the ABAQUS solid mechanics calculation process as a macro file in .PY format;
1.9) establishing a batch file which uses ABAQUS to execute the solid mechanics calculation module; importing the batch file into the ISIGHT general component SIMCODE; writing the maximum hydrostatic static pressure Pₘₐₓ on the wall surfaces of all the flow channels and the maximum node temperatur
$${T}_{m a x}^{a l}$$
of all the aluminum claddings, calculated by the CALCULATOR component, into ISIGHT to serve as intermediate variables and transmit to ABAQUS; reading the 3D geometric model file in .STP format; driving ABAQUS to perform solid mechanics calculation; saving the data after the calculation into a text file in.TXT format to realize integration between two pieces of software of ISIGHT and ABAQUS, wherein the text file in.TXT format stores maximum Mises equivalent stress
$${S}_{i}^{α} \left(i = 1 , 2 , … , 8\right)$$
of each fuel assembly core, the maximum Mises equivalent stress S_{θ} of the dentate plate, and the maximum Mises equivalent stress
$${S}_{i}^{β} \left(i = 1 , 2 , … , 7\right)$$
of each aluminum cladding;
1.10) integrating the CALCULATOR component based on the ISIGHT software; establishing a data processing module; using a max function in the component to process the data
$${S}_{i}^{α} , {S}_{θ} \text{and} {S}_{i}^{β}$$
extracted in step 1.9; and calculating the following data:
the overall maximum Mises stress
$${S}_{m a x} , {S}_{m a x} = max \left({S}_{1}^{α} , … , {S}_{7}^{α} , {S}_{1}^{β} , … , {S}_{7}^{β} , {S}_{θ}\right)$$
of the fuel assembly.

Second step: determining the design parameters, optimization objectives and constraint conditions of the optimization model, and selecting an appropriate experimental design method, surrogate model and optimization algorithm as follows:
2.1) the design parameters are selected as the widths Lᵢ (i = 1, 2, ...,8) of the flow channels because the heating power distribution of the fuel assembly core of the fuel assembly is not uniform, and the width of each flow channel has a very important influence on the heat dissipation of the fuel assembly core, which needs to determine the most effective flow channel width for heat dissipation of the fuel assembly;
2.2) as mentioned above, the heating power distribution of the fuel assembly core is not uniform; this non-uniformity leads to non-uniformity of temperature distribution of the fuel assembly core; if the temperature gradient between the fuel assembly cores is too large, the overall service life of the fuel assembly is greatly reduced; the standard deviation is usually used to describe the non-uniformity of the data distribution; and thus, the selection of the optimization objectives is described by a function as:
$$min {T}_{S D}^{f u e l} \left({L}_{1} , {L}_{2} , ⋯ , {L}_{8}\right)$$
where
$${T}_{S D}^{f u e l}$$
is the highest node temperature standard deviation of each fuel assembly core;

$${T}_{S D}^{f u e l} = \sqrt{\frac{{\sum }_{i = 1}^{7} {\left({T}_{i}^{α} - \overline{T}\right)}^{2}}{7} ;} {T}_{i}^{α}$$
is the highest node temperature of the ith fuel assembly core; T is the average value of the highest node temperature of each fuel assembly core;
$$\overline{T} = \frac{{\sum }_{i = 1}^{7} {T}_{i}^{α}}{7} ;$$
L₁,L₂, ..., L ₈ are the widths of the flow channels;
2.3) In addition to the important influence of non-uniform temperature distribution of the fuel assembly core on the service life of the fuel assembly, the average value Rₐᵥ of the comprehensive indicators of each flow channel, the overall maximum Mises stress Sₘₐₓ of the fuel assembly, and the highest node temperature
$${T}_{m a x}^{f u e l}$$
of all the fuel assembly cores also have a certain influence on the service life; it is expected that Rₐᵥ is as large as possible, Sₘₐₓ is as small as possible, and
$${T}_{m a x}^{f u e l}$$
is as small as possible, but the influences of the above three indicators are small relative to
$${T}_{S D}^{f u e l} ;$$
Rₐᵥ, Sₘₐₓ and
$${T}_{m a x}^{f u e l}$$
can be set as constraint conditions. In addition, limited by the space conditions for the placement of the fuel assembly, the width of each flow channel should also serve as a constraint.

The constraint conditions are described as:

$$\begin{matrix}- {R}_{a v} ⩽ - {R}_{0} \\ {T}_{m a x}^{f u e l} {}_{F u e l M A X} ⩽ {T}_{0} \\ {S}_{m a x} ⩽ {S}_{0} \\ 2 ⩽ {L}_{1} , {L}_{2} … , {L}_{8} ⩽ 3\end{matrix}$$

where

$${T}_{m a x}^{f u e l}$$

is the highest node temperature of all the fuel assembly cores; Sₘₐₓ is the maximum Mises equivalent stress under the flow-thermal-mechanical coupling action of the fuel assembly; R₀ is the minimum allowable value of the average comprehensive index of each flow channel; T₀ is the maximum allowable temperature of the fuel assembly; S₀ is the maximum allowable stress of the fuel assembly;

$${R}_{a v} = \frac{{\sum }_{i = 1}^{8} {R}_{i}}{8}$$

represents the average value of the comprehensive index of each flow channel;

$${R}_{i} = \frac{N {u}_{i} / N {u}_{0}}{{f}_{i} / {f}_{0}}$$

represents the comprehensive index of the ith flow channel; Nuᵢ ƒᵢ/ƒ₀ is the Nusselt number of the ith flow channel; Nu₀ is the Nusselt number of a reference flow channel; ƒᵢ represents a Darcy friction coefficient of the ith flow channel; ƒ₀ represents the Darcy friction coefficient of the reference flow channel;

$${f}_{i} = \frac{2 Δ {p}_{i} {D}_{i}}{{ρ}_{i} {U}_{i}^{2} L} ;$$

Δpᵢ is the outlet-inlet pressure drop (Pa) of the ith flow channel; Dᵢ is the hydraulic diameter (m) of the ith flow channel;pᵢ is the average density (kg/m³) of a coolant in the ith flow channel;Uᵢ is the inlet velocity (m/s) of the ith flow channel; and L is the length of each flow channel;

2.4) the experimental design method is selected from a “Latin hypercube” experimental design method which can ensure the full coverage of a selection range of each design variable (L₁,L₂,...,L₈) . The purpose of the design of experiments is to select different design parameter combinations

$$\left({L}_{1}^{j} , {L}_{2}^{j} , … , {L}_{8}^{j}\right) ,$$

and calculate the equivalent values of

$${R}_{a v}^{j} , {S}_{m a x}^{j} , {T}^{j} {}_{m a x}^{f u e l} \text{and} {T}^{j} {}_{S D}^{f u e l}$$

under each group of design parameter combinations. Each group of design parameter combinations and the calculated equivalent values of

$${R}_{a v}^{j} , {S}_{m a x}^{j} , {T}^{j} {}_{m a x}^{f u e l} \text{and} {T}^{j} {}_{S D}^{f u e l}$$

belong to one sample. The sample size is selected as 80, i.e., j =1, 2,..., 80 . The design parameter combination

$${L}_{1}^{j} , {L}_{2}^{j} , … , {L}_{8}^{j}$$

selected by the design of experiments is discrete data, and the design of experiments determines that different samples are the key prerequisites to ensure that the surrogate model is established accurately;

TABLE 4

| j | L₁ | L₂ | L₃ | L₄ | L₅ | L₆ | L₇ | L₈ |
|---|---|---|---|---|---|---|---|---|
| 1 | 2.00 | 2.53 | 2.51 | 2.41 | 2.17 | 2.51 | 2.10 | 2.68 |
| 2 | 2.01 | 2.03 | 2.92 | 2.73 | 2.24 | 2.68 | 2.20 | 2.87 |
| 3 | 2.03 | 2.73 | 2.53 | 2.05 | 2.18 | 2.15 | 2.86 | 2.41 |
| 4 | 2.04 | 2.86 | 2.32 | 2.60 | 2.56 | 2.37 | 2.70 | 2.61 |
| 5 | 2.05 | 2.44 | 2.30 | 2.00 | 2.29 | 2.52 | 2.63 | 2.92 |
| 6 | 2.06 | 2.77 | 2.84 | 2.85 | 2.49 | 2.41 | 2.43 | 2.28 |
| 7 | 2.08 | 2.14 | 2.87 | 2.39 | 2.30 | 2.33 | 2.91 | 2.53 |
| 8 | 2.09 | 2.10 | 2.72 | 2.79 | 2.37 | 2.13 | 2.23 | 2.82 |
| 9 | 2.10 | 2.42 | 2.03 | 2.66 | 2.22 | 2.23 | 3.00 | 2.72 |
| 10 | 2.11 | 2.52 | 2.10 | 2.44 | 2.82 | 2.77 | 2.61 | 2.67 |
| 11 | 2.13 | 2.35 | 2.23 | 2.54 | 2.47 | 2.70 | 2.48 | 2.46 |
| 12 | 2.14 | 2.01 | 2.99 | 2.65 | 2.03 | 2.79 | 2.22 | 2.49 |
| 13 | 2.15 | 2.15 | 2.22 | 2.46 | 2.11 | 2.11 | 2.82 | 2.05 |
| 14 | 2.17 | 2.75 | 2.85 | 2.19 | 2.57 | 2.73 | 2.58 | 2.98 |
| 15 | 2.18 | 2.19 | 2.00 | 2.15 | 2.04 | 2.80 | 2.54 | 2.04 |
| 16 | 2.19 | 2.65 | 2.71 | 2.32 | 2.14 | 3.00 | 2.18 | 2.60 |
| 17 | 2.20 | 2.04 | 2.77 | 2.87 | 2.90 | 2.43 | 2.65 | 2.75 |
| 18 | 2.22 | 2.62 | 2.54 | 2.72 | 2.72 | 2.04 | 2.56 | 2.84 |
| 19 | 2.23 | 2.27 | 2.25 | 2.90 | 2.66 | 2.87 | 2.75 | 2.20 |
| 20 | 2.24 | 2.11 | 2.66 | 2.56 | 2.79 | 2.85 | 2.42 | 2.51 |
| 21 | 2.25 | 2.25 | 2.06 | 2.25 | 2.63 | 2.28 | 2.95 | 2.81 |
| 22 | 2.27 | 2.32 | 2.57 | 2.37 | 2.84 | 2.39 | 2.94 | 2.11 |
| 23 | 2.28 | 2.85 | 2.91 | 2.42 | 2.95 | 2.44 | 2.25 | 2.96 |
| 24 | 2.29 | 2.80 | 2.46 | 2.53 | 2.41 | 2.18 | 2.66 | 2.77 |
| 25 | 2.30 | 2.51 | 2.89 | 2.61 | 2.48 | 2.10 | 2.77 | 2.65 |
| 26 | 2.32 | 2.56 | 2.81 | 2.62 | 2.05 | 2.76 | 2.89 | 2.58 |
| 27 | 2.33 | 3.00 | 2.76 | 2.24 | 2.60 | 2.30 | 2.57 | 2.15 |
| 28 | 2.34 | 2.54 | 2.68 | 2.52 | 2.39 | 2.19 | 2.06 | 2.01 |
| 29 | 2.35 | 2.98 | 2.67 | 2.04 | 2.27 | 2.47 | 2.62 | 2.80 |
| 30 | 2.37 | 2.49 | 2.90 | 2.89 | 2.06 | 2.22 | 2.60 | 2.13 |
| 31 | 2.38 | 2.84 | 2.37 | 2.33 | 2.28 | 2.99 | 2.52 | 2.14 |
| 32 | 2.39 | 2.72 | 2.04 | 2.77 | 2.34 | 2.00 | 2.05 | 2.56 |
| 33 | 2.41 | 2.28 | 2.27 | 2.63 | 2.61 | 2.09 | 2.96 | 2.06 |
| 34 | 2.42 | 2.82 | 2.96 | 2.22 | 2.08 | 2.84 | 2.80 | 2.43 |
| 35 | 2.43 | 2.29 | 2.29 | 2.70 | 2.20 | 2.61 | 2.32 | 2.66 |
| 36 | 2.44 | 2.38 | 2.39 | 2.86 | 2.80 | 2.75 | 2.85 | 2.57 |
| 37 | 2.46 | 2.20 | 2.05 | 2.11 | 2.38 | 2.91 | 2.99 | 2.99 |
| 38 | 2.47 | 2.34 | 2.13 | 2.18 | 2.87 | 2.65 | 2.92 | 2.38 |
| 39 | 2.48 | 2.99 | 2.48 | 2.30 | 2.70 | 2.32 | 2.46 | 2.24 |
| 40 | 2.49 | 2.22 | 2.94 | 2.34 | 2.89 | 2.86 | 2.84 | 2.18 |
| 41 | 2.51 | 2.13 | 2.86 | 2.08 | 2.00 | 2.29 | 2.90 | 2.86 |
| 42 | 2.52 | 2.41 | 2.14 | 3.00 | 2.01 | 2.38 | 2.38 | 2.29 |
| 43 | 2.53 | 2.61 | 2.56 | 2.91 | 3.00 | 2.66 | 2.15 | 2.94 |
| 44 | 2.54 | 2.89 | 2.11 | 2.96 | 2.65 | 2.94 | 2.73 | 2.34 |
| 45 | 2.56 | 2.92 | 2.80 | 2.28 | 2.58 | 2.06 | 2.33 | 2.70 |
| 46 | 2.57 | 2.90 | 2.52 | 2.71 | 2.15 | 2.17 | 2.67 | 2.35 |
| 47 | 2.58 | 2.60 | 2.63 | 2.09 | 2.85 | 2.71 | 2.14 | 2.42 |
| 48 | 2.60 | 2.05 | 2.01 | 2.48 | 2.68 | 2.03 | 2.00 | 2.17 |
| 49 | 2.61 | 2.58 | 2.62 | 2.68 | 2.67 | 2.63 | 2.03 | 2.39 |
| 50 | 2.62 | 2.39 | 2.70 | 2.20 | 2.62 | 2.89 | 2.79 | 2.19 |
| 51 | 2.63 | 2.96 | 2.58 | 2.13 | 2.33 | 2.53 | 2.72 | 2.95 |
| 52 | 2.65 | 2.71 | 3.00 | 2.10 | 2.73 | 2.57 | 2.17 | 2.62 |
| 53 | 2.66 | 2.81 | 2.65 | 2.51 | 2.35 | 2.46 | 2.28 | 2.89 |
| 54 | 2.67 | 2.87 | 2.17 | 2.14 | 2.75 | 2.01 | 2.29 | 2.27 |
| 55 | 2.68 | 2.43 | 2.47 | 2.17 | 2.13 | 2.67 | 2.01 | 2.85 |
| 56 | 2.70 | 2.18 | 2.34 | 2.82 | 2.52 | 2.62 | 2.71 | 2.08 |
| 57 | 2.71 | 2.46 | 2.41 | 2.75 | 2.09 | 2.25 | 2.51 | 2.30 |
| 58 | 2.72 | 2.24 | 2.38 | 2.94 | 2.51 | 2.08 | 2.27 | 2.48 |
| 59 | 2.73 | 2.09 | 2.42 | 2.49 | 2.98 | 2.60 | 2.47 | 2.44 |
| 60 | 2.75 | 2.00 | 2.98 | 2.03 | 2.19 | 2.20 | 2.41 | 2.76 |
| 61 | 2.76 | 2.76 | 2.20 | 2.98 | 2.81 | 2.58 | 2.35 | 3.00 |
| 62 | 2.77 | 2.63 | 2.44 | 2.38 | 2.86 | 2.34 | 2.34 | 2.71 |
| 63 | 2.79 | 2.48 | 2.24 | 2.67 | 2.53 | 2.54 | 2.08 | 2.54 |
| 64 | 2.80 | 2.23 | 2.33 | 2.27 | 2.96 | 2.98 | 2.04 | 2.32 |
| 65 | 2.81 | 2.91 | 2.15 | 2.81 | 2.77 | 2.27 | 2.09 | 2.33 |
| 66 | 2.82 | 2.95 | 2.49 | 2.76 | 2.92 | 2.81 | 2.19 | 2.52 |
| 67 | 2.84 | 2.94 | 2.82 | 2.92 | 2.25 | 2.14 | 2.24 | 2.73 |
| 68 | 2.85 | 2.57 | 2.35 | 2.01 | 2.91 | 2.49 | 2.44 | 2.10 |
| 69 | 2.86 | 2.67 | 2.60 | 2.23 | 2.54 | 2.96 | 2.13 | 2.22 |
| 70 | 2.87 | 2.66 | 2.79 | 2.95 | 2.46 | 2.35 | 2.76 | 2.23 |
| 71 | 2.89 | 2.37 | 2.73 | 2.58 | 2.76 | 2.82 | 2.87 | 2.25 |
| 72 | 2.90 | 2.68 | 2.19 | 2.29 | 2.94 | 2.24 | 2.81 | 2.91 |
| 73 | 2.91 | 2.79 | 2.95 | 2.84 | 2.23 | 2.90 | 2.98 | 2.09 |
| 74 | 2.92 | 2.08 | 2.61 | 2.35 | 2.43 | 2.95 | 2.68 | 2.00 |
| 75 | 2.94 | 2.17 | 2.18 | 2.43 | 2.99 | 2.48 | 2.53 | 2.90 |
| 76 | 2.95 | 2.47 | 2.75 | 2.57 | 2.32 | 2.92 | 2.30 | 2.63 |
| 77 | 2.96 | 2.06 | 2.43 | 2.47 | 2.10 | 2.05 | 2.39 | 2.47 |
| 78 | 2.98 | 2.33 | 2.28 | 2.06 | 2.71 | 2.56 | 2.49 | 2.03 |
| 79 | 2.99 | 2.30 | 2.09 | 2.99 | 2.42 | 2.72 | 2.37 | 2.79 |
| 80 | 3.00 | 2.70 | 2.08 | 2.80 | 2.44 | 2.42 | 2.11 | 2.37 |

2.5) the surrogate model is established based on the above samples after 80 groups of samples are selected using the “Latin hypercube” experimental design method; the purpose of the surrogate model is to make the discrete design variables “continuous” so as to use the optimization algorithm to predict an optimal solution. The surrogate model selects a Kriging surrogate model; the Kriging surrogate model has a good approximation effect when designing parameters within 10; and the accuracy of the surrogate model is verified by R².
$${R}^{2} = \frac{S S R}{S S T}$$
where
$$S S R = \sum {}_{i = 1}^{k} {\left({\hat{y}}_{i} - \overline{y}\right)}^{2}$$
represents the regression sum of squares;
$$S S T = \sum {}_{i = 1}^{k} {\left({\hat{y}}_{i} - \overline{y}\right)}^{2}$$
represents the total sum of squares; y̅ is the average value of the responses; ŷᵢ is a predicted value on a design point; yᵢ is a true value of the responses; and k is the number of sample points;
2.6) the optimization algorithm is a calculation method for predicting an optimal value after establishing the Kriging surrogate model; the optimization algorithm selects a “multi island genetic algorithm (MIGA)”; and the MIGA is a global optimization algorithm, which can effectively prevent an optimization result from falling into a local optimal solution. The optimal solution is a group of predicted design parameter values
$${{L}^{′}}_{1} , {{L}^{′}}_{2} , … , {{L}^{′}}_{8}$$
obtained by using the “MIGA”; corresponding
$${{R}^{′}}_{a v} , {{S}^{′}}_{m a x} , {{T}^{′}}_{m a x}^{f u e l} \text{and} {{T}^{′}}_{S D}^{f u e l}$$
under the design parameters
$${{L}^{′}}_{1} , {{L}^{′}}_{2} , … , {{L}^{′}}_{8}$$
are also predicted values;
$$2 \leq {{L}^{′}}_{1} , {{L}^{′}}_{2} , … , {{L}^{′}}_{8} \leq 3 ; \text{and} {{L}^{′}}_{1} , {{L}^{′}}_{2} , … , {{L}^{′}}_{8}$$
areany real numbers in a range [2,3], and may not necessarily belong to the combination
$${L}_{1}^{j} , {L}_{2}^{j} , … , {L}_{8}^{j}$$
selected by the design of experiments;
Third step: after the first and second steps are all ready, operating the fuel assembly co-simulation platform to carry out the relevant optimization operation; comparing the corresponding predicted value
$${{T}^{′}}_{S D}^{f u e l} \text{of} {{L}^{′}}_{1} , {{L}^{′}}_{2} , … , {{L}^{′}}_{8}$$
obtained by the optimization algorithm with a corresponding actual value
$${T}^{x} {}_{S D}^{f u e l} \text{of} {{L}^{′}}_{1} , {{L}^{′}}_{2} , … , {{L}^{′}}_{8}$$
obtained through numerical calculation; and analyzing the performance of the optimized fuel assembly, specifically as follows:
3.1) obtaining a group of predicted optimal design parameters
$${{L}^{′}}_{1} , {{L}^{′}}_{2} , … , {{L}^{′}}_{8}$$
after optimization with “MIGA”; under this group of design parameters, the corresponding
$${{R}^{′}}_{a v} , {{S}^{′}}_{m a x} \text{and} {{T}^{′}}_{m a x}^{f u e l}$$
satisfying
$$- {{R}^{′}}_{a v} \leq {R}_{0} , {{S}^{′}}_{m a x} \leq {S}_{0} \text{and} {{T}^{′}}_{m a x}^{f u e l} {}_{} \leq {T}_{0} ; {{T}^{′}}_{S D}^{f u e l}$$
is a minimum value in the surrogate model.
3.2) As described in step 1.1), the width of each flow channel has been parameterized, so the width of each flow channel is set as
$${{L}^{′}}_{1} , {{L}^{′}}_{2} , … , {{L}^{′}}_{8} ;$$
and the geometric model update module, the mesh update module, the flow and heat transfer calculation module, the solid mechanics calculation module and the data processing module are executed in sequence to obtain the real calculation data
$${\text{R}}_{a v}^{x} , {S}_{max}^{x} , {T}^{x} {}_{max}^{f u e l} {\text{and T}}^{x} {}_{S D}^{f u e l}$$
when the design parameters are
$${{L}^{′}}_{1} , {{L}^{′}}_{2} , … , {{L}^{′}}_{8} ;$$
3.3) judging whether data
$${R}_{a v}^{x} , {S}_{m a x}^{x} \text{and} {T}_{m a x}^{x f u e l} \text{satisfy} - {R}_{a v}^{x} ⩽ - 1.1 {R}_{0} , {S}_{m a x}^{x} ⩽ 1.1 {S}_{0}$$
and
$${T}_{m a x}^{x f u e l} ⩽ 1.1 {T}_{o} ,$$
and calculating an error
$$σ , σ = \frac{\left|{{T}^{′}}_{S D}^{f u e l} - {T}_{S D}^{x f u e l}\right|}{\left|{{T}^{′}}_{S D}^{f u e l}\right|}$$
between
$${T}^{′} {\text{}}_{S D}^{f u e l}$$
and
$${T}^{X} {}_{max}^{f u e l} ;$$
3.4) if the error described in step 3.3) is less than 10%,
$${R}_{a v}^{χ} , {S}_{m a x}^{χ}$$
and
$${T}^{χ} {}_{m a x}^{f u e l}$$
satisfy the requirements and the design parameters
$${{L}^{′}}_{1} , {{L}^{′}}_{2} , … , {{L}^{′}}_{8}$$
obtained after optimization are considered to be acceptable; if the error described in step 3.2) is greater than 10%, or any value of
$${R}_{a v}^{χ} , {S}_{m a x}^{χ}$$
and
$${T}^{χ} {}_{m a x}^{f u e l}$$
does not satisfy the requirements, the design parameters
$${{L}^{′}}_{1} , {{L}^{′}}_{2} , … , {{L}^{′}}_{8}$$
obtained after optimization are considered to be unacceptable, and the optimization process needs to be corrected;
3.5) the optimization process is modified by adding design samples of experiments, that is, adding samples based on the previous 80 groups of samples, reconstructing the surrogate model, reusing the optimization algorithm for optimization, and re-comparing the predicted value of the algorithm with the actual calculated value until the standards in steps 3.2) and 3.3) are satisfied.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A multidisciplinary structural design optimization method for a fuel assembly based on co-simulation, comprising the following steps:
first step: integrating NX, ICEM CFD, FLUENT and ABAQUS to build a fuel assembly co-simulation platform which comprises a geometric model update module, a mesh update module, a flow and heat transfer calculation module, a solid mechanics calculation module and a data processing module as follows:
1.1) establishing a geometric model of the fuel assembly in NX, which comprises 8 flow channels, 7 fuel assembly cores, 7 aluminum claddings and 1 dentate plate; parameterizing the sizes of 8 flow channel widths of the fuel assembly, exporting an NX expression file in .EXP format, recording an NX operation record file in .VB format, and outputting a geometric model file in .STP format;
1.2) establishing a batch file which uses NX to execute the geometric model update module; importing the batch file into an ISIGHT general component SIMCODE; writing the flow channel width parameters, obtained in step 1.1), in the NX expression file in .EXP format into ISIGHT to serve as design parameters; driving NX to update the geometric model; and outputting the updated general geometric model file in .STP format to realize integration between ISIGHT and NX;
1.3) saving an ICEM CFD meshing process as a macro file in .RPL format;
1.4) establishing a batch file which uses ICEM CFD to execute the mesh update module; importing the batch file into the ISIGHT general component SIMCODE; reading a general 3D geometric model file in .STP format; driving ICEM CFD to update the mesh; and outputting the updated mesh file in .MSH format to realize integration between two pieces of software of ISIGHT and ICEM CFD;
1.5) saving an FLUENT flow and heat transfer calculation process as a macro file in .JOU format;
1.6) establishing a batch file which uses FLUENT to execute a flow and heat transfer numerical calculation module; importing the batch file into ISIGHT general component SIMCODE; reading a mesh file in .MSH format and a UDF file in .C format; driving FLUENT for flow and heat transfer numerical calculation; and saving the data after the calculation into a text file in .VRP format to realize integration between two pieces of software of ISIGHT and FLUENT, wherein 4 .VRP text files are comprised and used to store the following content: comprehensive indexes Rᵢ (i =1,2,...,8) of each flow channel, the highest node temperature
$${T}_{i}^{α} \left(i = 1 , 2 , … , 7\right)$$
of each fuel assembly core, the highest node temperature
$${T}_{i}^{β} \left(i = 1 , 2 , … , 7\right)$$
of each aluminum cladding, and the maximum hydrostatic static pressure Pᵢ (i =1,2,...,8) of each channel wall surface;
1.7) integrating a CALCULATOR component; establishing a data processing module; using max, stdDev, sum functions in the component to process the data
$${R}_{i} , {T}_{i}^{α} , {T}_{i}^{β}$$
and Pᵢ extracted in step 1.6; and calculating the following data:
the highest node temperature
$${T}_{m a x}^{f u e l} , {T}_{m a x}^{f u e l} = max \left({T}_{1}^{α} , {T}_{2}^{α} , … , {T}_{7}^{α}\right)$$
of the fuel assembly core;
maximum node temperature standard deviation
$${T}_{S D}^{f u e l} , {T}_{S D}^{f u e l} = \text{stdDev} \left({T}_{1}^{α} , {T}_{2}^{α} , … , {T}_{7}^{α}\right)$$
of the fuel assembly core;
highest node temperature
$${T}_{m a x}^{a l} , {T}_{m a x}^{a l} = max \left({T}_{1}^{β} , {T}_{2}^{β} , … , {T}_{7}^{β}\right)$$
of all aluminum claddings;
maximum hydrostatic static pressure
$${P}_{m a x} , {P}_{m a x} = max \left({P}_{1} , {P}_{2} , … , {P}_{8}\right)$$
of each channel wall surface;
average value Rₐᵥ,Rₐᵥ=(sum(R₁,R₂,...,R₈))/8 of the comprehensive index of each flow channel;
1.8) saving the ABAQUS solid mechanics calculation process as a macro file in .PY format;
1.9) establishing a batch file which uses ABAQUS to execute the solid mechanics calculation module; importing the batch file into the ISIGHT general component SIMCODE; writing the maximum hydrostatic static pressure Pₘₐₓ on the wall surfaces of all the flow channels and the maximum node temperature
$${T}_{m a x}^{a l}$$
of all the aluminum claddings, calculated by the CALCULATOR component, into ISIGHT to serve as intermediate variables and transmit to ABAQUS; reading the 3D geometric model file in .STP format; driving ABAQUS to perform solid mechanics calculation; saving the data after the calculation into a text file in.TXT format to realize integration between two pieces of software of ISIGHT and ABAQUS, wherein the text file in.TXT format stores maximum Mises equivalent stress
$${S}_{i}^{α} \left(i = 1 , 2 , … , 8\right)$$
of each fuel assembly core, the maximum Mises equivalent stress S_{θ} of the dentate plate, and the maximum Mises equivalent stress
$${S}_{i}^{β} \left(i = 1 , 2 , … , 7\right)$$
of each aluminum cladding;
1.10) integrating the CALCULATOR component; establishing a data processing module; using a max function in the component to process the data
$${S}_{i}^{α} ,$$
S_{θ} and
$${S}_{i}^{β}$$
extracted in step 1.9; and calculating the following data:
the overall maximum Mises stress
$${S}_{m a x} , {S}_{m a x} = max \left({S}_{1}^{α} , … , {S}_{7}^{α} , {S}_{1}^{β} , … , {S}_{7}^{β} , {S}_{θ}\right)$$
of the fuel assembly;
second step: determining the design parameters, optimization objectives and constraint conditions of the optimization model, and selecting an appropriate experimental design method, surrogate model and optimization algorithm as follows:
2.1) the design parameters are the widths Lᵢ (i =1,2,...,8) of the flow channels;
2.2) the optimization objectives are described by a function as:
$$min {T}_{S D}^{f u e l} \left({L}_{1} , {L}_{2} , ⋯ , {L}_{8}\right)$$
where
$${T}_{S D}^{f u e l}$$
is the highest node temperature standard deviation of each fuel assembly core;
$${T}_{S D}^{f u e l} = \sqrt{\frac{{\sum }_{i = 1}^{7} {\left({T}_{i}^{α} - \overline{T}\right)}^{2}}{7}} ; {T}_{i}^{α}$$
is the highest node temperature of the ith fuel assembly core; T̅ is the average value of the highest node temperature of each fuel assembly core;
$$\overline{T} = \frac{{\sum }_{i = 1}^{7} {T}_{i}^{α}}{7} ;$$
L₁,L₂,...,L₈ are the widths of the flow channels;
2.3) the constraint conditions are Rₐᵥ,Sₘₐₓ,
$${T}_{m a x}^{f u e l}$$
and the width of each flow channel;
the constraint conditions are described as:
$$\begin{matrix}- {R}_{a v} ⩽ - {R}_{0} \\ {T}_{m a x F u e l M A X}^{f u e l} ⩽ {T}_{0} \\ {S}_{m a x} ⩽ {S}_{0} \\ 2 ⩽ {L}_{1} , {L}_{2} … , {L}_{8} ⩽ 3\end{matrix}$$
where
$${T}_{m a x}^{f u e l}$$
is the highest node temperature of all the fuel assembly cores; Sₘₐₓ is the maximum Mises equivalent stress under the flow-thermal-mechanical coupling action of the fuel assembly; R₀ is the minimum allowable value of the average comprehensive index of each flow channel; T₀ is the maximum allowable temperature of the fuel assembly; S₀ is the maximum allowable stress of the fuel assembly;
$${R}_{a v} = \frac{{\sum }_{i = 1}^{8} {R}_{i}}{8}$$
represents the average value of the comprehensive index of each flow channel;
$${R}_{i} = \frac{N {u}_{i} / N {u}_{0}}{{f}_{i} / {f}_{0}}$$
represents the comprehensive index of the ith flow channel; Nuᵢ is the Nusselt number of the ith flow channel; Nu₀ is the Nusselt number of a reference flow channel;
fᵢ represents a Darcy friction coefficient of the ith flow channel; f₀ represents the Darcy friction coefficient of the reference flow channel;
$${f}_{i} = \frac{2 Δ {p}_{i} {D}_{i}}{{ρ}_{i} {U}_{i}^{2} L} ; Δ {p}_{i}$$
is the outlet-inlet pressure drop (Pa) of the ith flow channel; Dᵢ is the hydraulic diameter (m) of the ith flow channel; ρᵢ is the average density (kg/m³) of a coolant in the ith flow channel;Uᵢ is the inlet velocity (m/s) of the ith flow channel; and L is the length of each flow channel;
2.4) using the experimental design method to select different design parameter combinations
$$\left({L}_{1}^{i} , {L}_{2}^{i} , … , {L}_{8}^{i}\right) ,$$
and calculate the equivalent values of
$${R}_{a v}^{j} , {S}_{m a x}^{j} , {T}_{m a x}^{j f u e l} \text{and} {T}_{S D}^{j f u e l}$$
under each group of design parameter combinations; each group of design parameter combinations and the calculated equivalent values of
$${R}_{a v}^{j} , {S}_{m a x}^{j} , {T}_{m a x}^{j f u e l} \text{and} {T}_{S D}^{j f u e l}$$
belong to one sample;
2.5) the surrogate model is established based on the above samples after the samples are selected using the experimental design method of step 2.4); and making the discrete design variables “continuous” so as to use the optimization algorithm to predict an optimal solution;
2.6) the optimization algorithmcan effectively prevent an optimization result from falling into a local optimal solution; the optimal solution is a group of predicted design parameter values
$${{L}^{′}}_{1} , {{L}^{′}}_{2} , … , {{L}^{′}}_{8}$$
obtained by using the optimization algorithm, wherein
$$2 ⩽ {{L}^{′}}_{1} , {{L}^{′}}_{2} , … , {{L}^{′}}_{8} ⩽ 3 ;$$
and corresponding
$${{R}^{′}}_{a v} , {{S}^{′}}_{m a x} , {{T}^{′}}_{m a x}^{f u e l} \text{and} {{T}^{′}}_{S D}^{f u e l}$$
under the design parameters
$${{L}^{′}}_{1} , {{L}^{′}}_{2} , … , {{L}^{′}}_{8}$$
are also predicted values;
third step: operating the fuel assembly co-simulation platform to carry out optimization operation; comparing the corresponding predicted value
$${{T}^{′}}_{S D}^{f u e l} \text{of} {{L}^{′}}_{1} , {{L}^{′}}_{2} , … , {{L}^{′}}_{8}$$
obtained by the optimization algorithm with a corresponding actual value
$${T}^{χ} {}_{S D}^{f u e l} \text{of} {{L}^{′}}_{1} , {{L}^{′}}_{2} , … , {{L}^{′}}_{8}$$
obtained through numerical calculation; and analyzing the performance of the optimized fuel assembly, specifically as follows:
3.1) obtaining a group of predicted optimal design parameters
$${{L}^{′}}_{1} , {{L}^{′}}_{2} , … , {{L}^{′}}_{8}$$
after optimization with the optimization algorithm of step 2.6); under this group of design parameters, the corresponding
$${{R}^{′}}_{a v} , {{S}^{′}}_{m a x} \text{and} {{T}^{′}}_{m a x}^{f u e l}$$
satisfying
$$- {{R}^{′}}_{a v} ⩽ {R}_{0} , {{S}^{′}}_{m a x} ⩽ {S}_{0} \text{and} {{T}^{′}}_{m a x}^{f u e l} ⩽ {T}_{0} ; {{T}^{′}}_{S D}^{f u e l}$$
is a minimum value in the surrogate model;
3.2) setting the width of each flow channel as
$${{L}^{′}}_{1} , {{L}^{′}}_{2} , … , {{L}^{′}}_{8} ;$$
and executing the geometric model update module, the mesh update module, the flow and heat transfer calculation module, the solid mechanics calculation module and the data processing module in sequence to obtain the real calculation data
$${R}_{a v}^{χ} , {S}_{m a x}^{χ} , {T}^{χ} {}_{m a x}^{f u e l} \text{and} {T}^{χ} {}_{S D}^{f u e l}$$
when the design parameters are
$${{L}^{′}}_{1} , {{L}^{′}}_{2} , … , {{L}^{′}}_{8} ;$$
3.3) judging whether data
$${R}_{a v}^{χ} , {S}_{m a x}^{χ} \text{and} {\text{T}}^{χ} {}_{m a x}^{f u e l}$$
satisfy
$$- {R}_{a v}^{χ} ⩽ - 1.1 {R}_{0} , {S}_{m a x}^{χ} ⩽ 1.1 {S}_{0}$$
and
$${T}^{χ} {}_{m a x}^{f u e l} ⩽ 1.1 {T}_{0} ,$$
and calculating an error σ,
$$σ = \frac{\left|{T}^{′} {}_{S D}^{f u e l} - {T}^{χ} {}_{S D}^{f u e l}\right|}{\left|{T}^{′} {}_{S D}^{f u e l}\right|}$$
between
$${T}^{′} {\text{}}_{S D}^{f u e l}$$
and
$${T}^{χ} {}_{m a x}^{f u e l} ;$$
3.4) if the error described in step 3.3) is less than 10%,
$${R}_{a v}^{χ} , {S}_{m a x}^{χ} \text{and} {\text{T}}^{χ} {}_{m a x}^{f u e l}$$
satisfy the requirements and the design parameters
$${{L}^{′}}_{1} , {{L}^{′}}_{2} , … , {{L}^{′}}_{8}$$
obtained after optimization are considered to be acceptable; if the error described in step 3.2) is greater than 10%, or any value of
$${R}_{a v}^{χ} , {S}_{m a x}^{χ}$$
and
$${T}^{χ} {}_{m a x}^{f u e l}$$
does not satisfy the requirements, the design parameters
$${{L}^{′}}_{1} , {{L}^{′}}_{2} , … , {{L}^{′}}_{8}$$
obtained after optimization are considered to be unacceptable, and the optimization process needs to be corrected;
3.5) the optimization process is modified by adding design samples of experiments, that is, adding samples based on the previous samples, reconstructing the surrogate model, reusing the optimization algorithm for optimization, and re-comparing the predicted value of the algorithm with the actual calculated value until the standards in steps 3.2) and 3.3) are satisfied.

2. The multidisciplinary structural design optimization method for the fuel assembly based on co-simulation according to claim 1, wherein the experimental design method in step 2.4) is a “Latin hypercube” experimental design method.

3. The multidisciplinary structural design optimization method for the fuel assembly based on co-simulation according to claim 1, wherein in step 2.5),the surrogate model selects a Kriging surrogate model, and the accuracy of the surrogate model is verified by R² ;
$${R}^{2} = \frac{S S R}{S S T}$$
where
$$S S R = {\sum }_{i = 1}^{k} {\left({\hat{y}}_{i} - \overline{y}\right)}^{2}$$
represents the regression sum of squares;
$$S S T = {\sum }_{i = 1}^{k} {\left({y}_{i} - \overline{y}\right)}^{2}$$
represents the total sum of squares; y̅ is the average value of the responses; ŷᵢ is a predicted value on a design point; yᵢ is a true value of the responses; and k is the number of sample points.

4. The multidisciplinary structural design optimization method for the fuel assembly based on co-simulation according to claim 1, wherein in step 2.6), the optimization algorithm selects a “multi island genetic algorithm (MIGA).
